(19) United States
(12) Patent Application Publication
(10) Pub. No.: US 2026/0046167 A1
(43) Pub. Date: Feb. 12, 2026

(54) Communication Method and Apparatus

(71) Applicant: HUAWEI TECHNOLOGIES CO., LTD., Shenzhen (CN)

(72) Inventors: Chenchen Liu, Shenzhen (CN); Bin Qian, Shenzhen (CN); Lei Huang, Singapore (SG); Xun Yang, Singapore (SG)

(73) Assignee: HUAWEI TECHNOLOGIES CO., LTD., Shenzhen (CN)

(21) Appl. No.: 19/359,972

(22) Filed: Oct. 16, 2025

Related U.S. Application Data
(63) Continuation of application No. PCT/CN2024/085169, filed on Apr. 1, 2024.

(30) Foreign Application Priority Data
Apr. 17, 2023 (CN) 202310454036.6

(51) Int. Cl. H04L 25/02

(52) U.S. Cl. CPC H04L 25/0212

(57) ABSTRACT

A communication method includes: receiving first indication information, and sending first channel impulse response (CIR) information based on the first indication information. The first indication information indicates one or more CIR groups that need to be fed back in a CIR window, and each CIR group that needs to be fed back includes an (I)^{th} CIR tap and a (II)^{th} CIR tap that are in the CIR window, and all CIR taps between the (I)^{th} CIR tap and the (II)^{th} CIR tap. The first CIR information is the one or more CIR groups that are indicated by the first indication information and that need to be fed back.

### CROSS-REFERENCE TO RELATED APPLICATIONS

This is a continuation of International Patent Application No. PCT/CN2024/085169 filed on Apr. 1, 2024, which claims priority to Chinese Patent Application No. 202310454036.6 filed on Apr. 17, 2023. The disclosures of the aforementioned applications are hereby incorporated by reference in their entireties.

### TECHNICAL FIELD

This disclosure relates to the field of mobile communication technologies, and in particular, to a communication method and apparatus.

### BACKGROUND

An ultra-wideband (UWB) technology is a wireless carrier communication technology in which a nanosecond-level non-sinusoidal narrow pulse is used for data transmission. Therefore, the UWB occupies a wide spectrum range. Due to a narrow pulse and extremely low radiation spectrum density of the UWB, a UWB system has advantages such as a strong multi-path resolution capability, low power consumption, and high confidentiality. The UWB technology can be applied to various communication scenarios.

In an application of a sensing scenario, information like a distance, an angle, and a speed of a target may be extracted by detecting an echo of a UWB signal on the target, to implement target sensing. When a sensing receiver is a receive device of the UWB signal, the sensing receiver needs to transmit a measurement result of a channel impulse response (CIR) to a sensing transmitter through an air interface, to feed back a sensing result. In a CIR window-based CIR feedback mechanism, the sensing receiver may send, to the sensing transmitter based on an indication of a CIR tap that needs to be fed back, the CIR tap that is in a CIR window and that needs to be fed back, to feed back the sensing result. Each CIR tap may indicate a sensing result of a specific time granularity in the CIR window. The indication may indicate the CIR tap that needs to be fed back. Therefore, the sensing receiver may send only the CIR tap that needs to be fed back, and does not need to send a CIR tap other than the CIR tap that needs to be fed back, to reduce overheads.

Currently, the sensing transmitter needs to indicate whether each CIR tap in the CIR window needs to be fed back, and indication overheads are high.

### SUMMARY

This disclosure provides a communication method and apparatus, to reduce indication overheads of a CIR tap feedback.

According to a first aspect, a communication method is provided. The method may be implemented by a first terminal apparatus. The first terminal apparatus may be a sensing receiver or a component of the sensing receiver. The sensing receiver may be a network device or a terminal device. The component in this disclosure may include, for example, at least one of a chip, a chip system, a processor, a transceiver, a processing unit, or a transceiver unit. For example, an execution body is the first terminal apparatus. The method may be implemented by using the following steps: The first terminal apparatus receives first indication information. The first indication information indicates one or more CIR groups that need to be fed back in a CIR window, and each CIR group that needs to be fed back includes an (s₁2^{t}^{₁}+1)^{th} CIR tap and an (s₂2^{t}^{₂})^{th} CIR tap that are in the CIR window, and all CIR taps between the (s₁2^{t}^{₁}+1)^{th} CIR tap and the (s₂2^{t}^{₂})^{th} CIR tap. s₁ and s₂ are positive integers, and t₁ and t₂ are positive integers. The first terminal apparatus may further send first CIR information. The first CIR information is the one or more CIR groups that are indicated by the first indication information and that need to be fed back.

According to the method shown in the first aspect, the first terminal apparatus may determine, based on the first indication information, the one or more CIR groups that need to be fed back, and send the first CIR information corresponding to the CIR groups that need to be fed back. The first indication information may indicate at least one CIR group that is in the CIR window and that needs to be fed back. Because it does not need to indicate whether all the CIR taps in the CIR window need to be fed back, and the CIR tap that needs to be fed back is indicated on a per-group basis, indication overheads can be reduced.

In a possible implementation, each CIR group includes s₂2^{t}^{₂}−s₁2^{t}^{₁} CIR taps. Optionally, s₂2^{t}^{₂}−s₁2^{t}^{₁} is greater than 1.

In a possible implementation, CIR taps in the CIR window include a 1^{st} CIR tap and a (2^{K})^{th} CIR tap that are in the CIR window, and all CIR taps between the 1^{st} CIR tap and the (2^{K})^{th} CIR tap, and include 2K CIR taps in total. K is a positive integer greater than 2.

Based on this implementation, flexible grouping setting can be implemented, to support an indication solution of the CIR tap that needs to be fed back in this disclosure.

In a possible implementation, the first CIR information includes a first CIR group, and the first CIR group includes a (2^{k}^{₁}+1)^{th} CIR tap, a (2^{k}^{₂})^{th} CIR tap, and all CIR taps between the (2^{k}^{₁}+1)^{th} CIR tap and the (2^{k}^{₂})^{th} CIR tap. k₁ and k₂ are non-negative integers, and k₁<k₂≤K.

In a possible implementation, the first indication information corresponds to the first CIR group. Optionally, a correspondence between the first indication information and the first CIR group is included in a correspondence list, and CIR groups included in the list are a part of all CIR groups in the CIR window, to further reduce the indication overheads.

In a possible implementation, the first CIR information further includes a second CIR group, and the second CIR group includes a (2^{k}^{₃}+1)^{th} CIR tap, a (2^{k}^{₄})^{th} CIR tap, and all CIR taps between the (2^{k}^{₃}+1)^{th} CIR tap and the (2^{k}^{₄})^{th} CIR tap. k₃ and k₄ are non-negative integers, and k₃<k₄≤K.

Based on this implementation, the first CIR information may indicate a plurality of CIR groups. Therefore, in comparison with a solution in which the plurality of CIR groups are separately indicated by using different signaling, indicating the plurality of CIR groups by using same indication information can further reduce the indication overheads.

In a possible implementation, the first indication information corresponds to the first CIR group and the second CIR group.

Based on this implementation, the first indication information corresponds to the plurality of CIR groups that need to be fed back. Optionally, a correspondence between the first indication information, and the first CIR group and the second CIR group is included in a correspondence list, and CIR groups included in the list are a part of all CIR groups in the CIR window, to further reduce the indication overheads.

In a possible implementation, a 1^{st} CIR tap in the first CIR information is a (k₅2^{d}+1)^{th} CIR tap in the CIR window, and a last CIR tap in the first CIR information is a ((k₆+1)2^{d})^{th} CIR tap in the CIR window. d is a positive integer, K>d, k₅ and k₆ are non-negative integers, k₅∈[0, 2^{K-d}−1], and k₆∈[0, 2^{K-d}−1].

Based on this implementation, the first indication information may separately indicate k₅ and k₆, to indicate a start location and an end location of the CIR group, to reduce indication overheads.

In a possible implementation, the first indication information includes 2(K−d) bits, first K−d bits in the first indication information indicate k₅, and last K−d bits in the first indication information indicate k₆.

According to a second aspect, a communication method is provided. The method may be implemented by a second communication apparatus. The second communication apparatus may be a sensing transmitter or a component of the sensing transmitter. The sensing transmitter may be a terminal device or a network device. The component in this disclosure may include, for example, at least one of a chip, a chip system, a processor, a transceiver, a processing unit, or a transceiver unit. For example, an execution body is the second communication apparatus. The method may be implemented by using the following steps: The second communication apparatus sends first indication information, where the first indication information indicates one or more CIR groups that need to be fed back in a CIR window, and each CIR group that needs to be fed back includes an (s₁2^{t}^{₁}+1)^{th} CIR tap and an (s₂2^{t}^{₂})^{th} CIR tap that are in the CIR window, and all CIR taps between the (s₁2^{t}^{₁}+1)^{th} CIR tap and the (s₂2^{t}^{₂})^{th} CIR tap, where s₁ and s₂ are positive integers, and t₁ and t₂ are positive integers; and receives first CIR information, where the first CIR information is the one or more CIR groups that are indicated by the first indication information and that need to be fed back.

In a possible implementation, each CIR group includes s₂2^{t}^{₂}−s₁2^{t}^{₁} CIR taps.

In a possible implementation, CIR taps in the CIR window include a 1^{st} CIR tap and a (2^{K})^{th} CIR tap that are in the CIR window, and all CIR taps between the 1^{st} CIR tap and the (2^{K})^{th} CIR tap, and include 2K CIR taps in total. K is a positive integer greater than 2.

In a possible implementation, the first CIR information includes a first CIR group, and the first CIR group includes a (2^{k}^{₁}+1)^{th} CIR tap, a (2^{k}^{₂})^{th} CIR tap, and all CIR taps between the (2^{k}^{₁}+1)^{th} CIR tap and the (2^{k}^{₂})^{th} CIR tap. k₁ and k₂ are non-negative integers, and k₁<k₂≤K.

In a possible implementation, the first indication information corresponds to the first CIR group.

In a possible implementation, the first CIR information further includes a second CIR group, and the second CIR group includes a (2^{k}^{₃}+1)^{th} CIR tap, a (2^{k}^{₄})^{th} CIR tap, and all CIR taps between the (2^{k}^{₃}+1)^{th} CIR tap and the (2^{k}^{₄})^{th} CIR tap. k₃ and k₄ are non-negative integers, and k₃<k₄≤K.

In a possible implementation, the first indication information corresponds to the first CIR group and the second CIR group.

In a possible implementation, a 1^{st} CIR tap in the first CIR information is a (k₅2^{d}+1)^{th} CIR tap in the CIR window, and a last CIR tap in the first CIR information is a ((k₆+1)2^{d})^{th} CIR tap in the CIR window. d is a positive integer, K>d, k₅ and k₆ are non-negative integers, k₅∈[0, 2^{K-d}−1], and k₆∈[0, 2^{K-d}−1].

In a possible implementation, the first indication information includes 2(K−d) bits, first K−d bits in the first indication information indicate k₅, and last K−d bits in the first indication information indicate k₆.

According to a third aspect, a communication apparatus is provided. The apparatus may implement the method according to any possible design of the first aspect or the second aspect. The apparatus has a function of the first communication apparatus or the second communication apparatus. The apparatus is, for example, a sensing transmitter, a sensing receiver, a component of the sensing transmitter, or a component of the sensing receiver.

In an optional implementation, the apparatus may include modules that perform and that one-to-one correspond to the methods/operations/steps/actions described in any possible implementation of the first aspect or the second aspect. The module may be a hardware circuit, or may be software, or may be implemented by a hardware circuit in combination with software. In an optional implementation, the apparatus includes a processing unit (sometimes also referred to as a processing module) and a communication unit (sometimes also referred to as a transceiver module, a communication module, or the like). The transceiver unit can implement a sending function and a receiving function. When the transceiver unit implements the sending function, the transceiver unit may be referred to as or include a sending unit (sometimes also referred to as a sending module). When the transceiver unit implements the receiving function, the transceiver unit may be referred to as or include a receiving unit (sometimes also referred to as a receiving module). The sending unit and the receiving unit may be a same functional module, the functional module is referred to as the transceiver unit, and the functional module can implement the sending function and the receiving function. Alternatively, the sending unit and the receiving unit may be different functional modules, and the transceiver unit is a general term for these functional modules.

For example, when the apparatus is configured to perform the method described in any possible implementation of the first aspect or the second aspect, the apparatus may include the communication unit and the processing unit. The processing unit may include the sending unit and/or the receiving unit.

According to a fourth aspect, an embodiment of this disclosure further provides a communication apparatus, including a processor, configured to execute a computer program (or computer executable instructions) stored in a memory. When the computer program (or the computer executable instructions) is executed, the apparatus is enabled to perform the method according to the first aspect, the second aspect, or the possible implementations of the first aspect and the second aspect.

In a possible implementation, the processor and the memory are integrated together.

In another possible implementation, the memory is located outside the communication apparatus.

The communication apparatus further includes a communication interface. The communication interface is used for communication between the communication apparatus and another device, for example, used for data and/or signal sending or receiving. For example, the communication interface may be a transceiver, a circuit, a bus, a module, or another type of communication interface.

According to a fifth aspect, a computer-readable storage medium is provided. The computer-readable storage medium is configured to store a computer program or instructions, and when the computer program or the instructions are run, the method shown in any one of the first aspect, the second aspect, or the possible implementations of the first aspect and the second aspect is implemented.

According to a sixth aspect, a computer program product including instructions is provided. When the computer program product runs on a computer, the method shown in any one of the first aspect, the second aspect, or the possible implementations of the first aspect and the second aspect is implemented.

According to a seventh aspect, an embodiment of this disclosure further provides a communication apparatus, configured to perform the method according to the first aspect, the second aspect, or various possible implementations of the first aspect and the second aspect.

According to an eighth aspect, a chip system is provided. The chip system includes a logic circuit (which may alternatively be understood as that the chip system includes a processor, and the processor may include a logic circuit and the like), and may further include an input/output interface. The input/output interface may be configured to input a message, or may be configured to output a message. The input/output interface may be a same interface, to be specific, a same interface can implement both a sending function and a receiving function. Alternatively, the input/output interface includes an input interface and an output interface. The input interface is configured to implement a receiving function, that is, configured to receive a message. The output interface is configured to implement a sending function, that is, configured to send a message. The logic circuit may be configured to perform an operation other than the sending and receiving functions in the method shown in any one of the first aspect, the second aspect, or the possible implementations of the first aspect and the second aspect. The logic circuit may be further configured to transmit a message to the input/output interface, or receive, from the input/output interface, a message from another communication apparatus. The chip system may be configured to implement the method according to any one of the first aspect, the second aspect, or the possible implementations of the first aspect and the second aspect. The chip system may include a chip, or may include a chip and another discrete component.

Optionally, the chip system may further include a memory, and the memory may be configured to store instructions. The logic circuit may invoke the instructions stored in the memory to implement a corresponding function.

According to a ninth aspect, a communication system is provided. The communication system may include a first communication apparatus and a second communication apparatus, which are separately configured to implement the method according to any one of the first aspect, the second aspect, and the possible implementations of the first aspect and the second aspect.

For technical effect brought by the second aspect to the ninth aspect, refer to the descriptions of the first aspect. Details are not described herein again.

### BRIEF DESCRIPTION OF DRAWINGS

FIG. 1 is a diagram of a structure of a star topology according to an embodiment of this disclosure;

FIG. 2 is a diagram of a structure of a point-to-point topology according to an embodiment of this disclosure;

FIG. 3 is a diagram of a CIR window according to an embodiment of this disclosure;

FIG. 4 is a schematic flowchart of a communication method according to an embodiment of this disclosure;

FIG. 5 is a diagram of CIR grouping according to an embodiment of this disclosure;

FIG. 6 is a diagram of a structure of a communication apparatus according to an embodiment of this disclosure;

FIG. 7 is a diagram of a structure of another communication apparatus according to an embodiment of this disclosure; and

FIG. 8 is a diagram of a structure of another communication apparatus according to an embodiment of this disclosure.

### DESCRIPTION OF EMBODIMENTS

In this disclosure, “at least one” means one or more, and “a plurality of” means two or more. The term “and/or” describes an association relationship for describing associated objects and indicates that three relationships may exist. For example, A and/or B may indicate the following cases: only A exists, both A and B exist, and only B exists, where A and B may be singular or plural. In the text descriptions of this disclosure, the character “/” indicates an “or” relationship between the associated objects. In a formula in this disclosure, the character “/” indicates a “division” relationship between the associated objects. “Including at least one of A, B, and C” may represent: including A; including B; including C; including A and B; including A and C; including B and C; and including A, B, and C.

The technical solutions provided in this disclosure are applicable to a UWB-based wireless personal area network (WPAN). For example, a method provided in this disclosure is applicable to Institute of Electrical and Electronics Engineers (IEEE) 802.15 series protocols, for example, the 802.15.4a protocol, the 802.15.4z protocol, the 802.15.4ab protocol, or a future generation of UWB WPAN standard. Examples are not enumerated herein. The method provided in this disclosure may be further applied to various communication systems, for example, an Internet of things (IoT) system, vehicle to everything (V2X), or a narrowband Internet of things (NB-IoT) system, and is applied to a device in the vehicle to everything, an IoT node, a sensor, or the like in the IoT, a smart camera, a smart remote control, and a smart water meter or electricity meter in smart home, and a sensor in a smart city. The method provided in this disclosure is also applicable to an Long-Term Evolution (LTE) frequency-division duplex (FDD) system, an LTE time-division duplex (TDD) system, a Universal Mobile Telecommunications System (UMTS), a Worldwide Interoperability for Microwave Access (WiMAX) communication system, an LTE system, a 5th generation (5G) communication system, a 6th generation (6G) communication system, or the like.

The following first explains some terms in embodiments of this disclosure.

(1) Sensing may also be referred to as sensing measurement or radio sensing, means that a transmitter and a receiver transmit a signal to implement an objective of discovering a target or determining a target status. UWB sensing means that a station (STA) with a UWB signal sensing capability uses a received UWB signal to detect a feature of an expected target in a given environment. For example, the feature includes one or more of a range, a speed, an angle, a motion, existence or proximity, a gesture, and the like. The target includes one or more of an object, a person, an animal, and the like. The environment includes one or more of a room, a house, a vehicle, an enterprise, and the like.

For example, the transmitter may send the UWB signal used for sensing measurement to the receiver, and the receiver may measure the signal to obtain a channel estimation result, for example, a CIR. The receiver may perform sensing based on the CIR. Alternatively, the receiver may send the channel estimation result to the transmitter, and the transmitter performs target sensing or target status sensing based on the channel estimation result. For example, the receiver or the transmitter may process the CIR, to determine whether a moving object exists in the environment.

During specific implementation, sensing signals may be sent one by one in a form of a data packet, and therefore, may also be referred to as a sensing packet (SP).

In some embodiments, sensing signals sent in a period of time on a frequency band may be referred to as a sensing fragment (SF), and each SF may have one or more SPs. It may be understood that, when a quantity of SPs in the SF is determined, the SPs may alternatively be the SF.

In a sensing process, devices participating in sensing include a sensing initiator, a sensing responder, a sensing transmitter, and a sensing receiver.

(2) The sensing initiator is also referred to as a sensing initiator device or an initiator, and is a device that initiates a sensing procedure.

(3) The sensing responder is also referred to as a sensing responder device, a responder device, a responder, or a response device, and is a device that responds to sensing initiated by the sensing initiator and participates in sensing.

(4) The sensing transmitter is also referred to as a transmitting end, and is a device that sends the sensing signal. The sensing signal may be a signal used for sensing measurement.

(5) The sensing receiver is also referred to as a receiving end, and is a device that receives the sensing signal. The sensing receiver may measure the sensing signal.

During specific implementation, the sensing initiator may serve as the transmitter, and the sensing responder may serve as the receiver. Alternatively, the sensing initiator may serve as the receiver, and the sensing responder may serve as the transmitter.

The sensing initiator may be a network device or a terminal device, and the sensing responder may be a network device or a terminal device. The network device may include an access network device, a core network (CN) device, and the like. The terminal is connected to a radio access network device in a wireless manner, and the radio access network device is connected to the CN in a wireless or wired manner. The CN device and the radio access network device may be different independent physical devices, functions of the CN device and logical functions of the radio access network device may be integrated into a same physical device, or some functions of the CN device and some functions of the radio access network device may be integrated into one physical device. A wired or wireless manner may be used for connection between terminals and between radio access network devices.

For example, the access network device is an access device used by the terminal to access a communication system in a wireless manner. For example, the radio access network device may be a base station, an evolved NodeB (eNodeB), a transmission reception point (TRP), a next generation NodeB (gNB) in a 5G mobile communication system, a next generation base station in a 6G mobile communication system, a base station in a future mobile communication system, an access node in a WI-FI system, a long range radio (LoRa) system, or a vehicle-to-everything system, or the like. The radio access network device may alternatively be a module or a unit that completes a part of functions of the base station, for example, may be a central unit (CU), or may be a distributed unit (DU). The CU herein implements functions of a radio resource control protocol and a Packet Data Convergence Protocol (PDCP) of the base station, and may further implement functions of a Service Data Adaptation Protocol (SDAP). The DU completes functions of a radio link control layer and a medium access control (MAC) layer of the base station, and may further complete functions of a part or all of a physical layer. For specific descriptions of the foregoing protocol layers, refer to technical specifications related to the 3rd Generation Partnership Project (3GPP). The radio access network device may be a macro base station, may be a micro base station or an indoor base station, or may be a relay node, a donor node, or the like. A specific technology and a specific device form that are used by the radio access network device are not limited in embodiments of this disclosure. For ease of description, a network device is used as an abbreviation of the radio access network device, and the base station is used as an example of the radio access network device.

The terminal device is a device having a wireless transceiver function, and may send a signal to the base station, or receive a signal from the base station. The terminal may also be referred to as a terminal device, user equipment (UE), a mobile station, a mobile terminal, or the like. The terminal may be widely used in various scenarios, for example, device-to-device (D2D), V2X communication, machine-type communication (MTC), IoT, virtual reality, augmented reality, industrial control, autonomous driving, telemedicine, smart grid, smart furniture, smart office, smart wearable, smart transportation, and smart city. The terminal may be a mobile phone, a tablet computer, a computer with a wireless sending and receiving function, a wearable device, a vehicle, an airplane, a ship, a robot, a robotic arm, a smart home device, or the like. A specific technology and a specific device form that are used by the terminal are not limited in embodiments of this disclosure.

The base station and the terminal may be fixed or movable. The base station and the terminal may be deployed on land, including an indoor or outdoor device, a hand-held device, or a vehicle-mounted device, or may be deployed on water, or may be deployed on an airplane, a balloon, or an artificial satellite. Application scenarios of the base station and the terminal are not limited in embodiments of this disclosure.

(6) The frequency band may refer to a frequency domain range. For example, in a UWB system, a bandwidth of 499.2 megahertz (MHz) may be referred to as a frequency band.

(7) A time unit is a time range determined by duration, for example, a frame, a subframe, a sensing slot, a sensing round, a sensing block, or a symbol. This is not limited in this disclosure. For example, one slot may be duration of 9 microseconds.

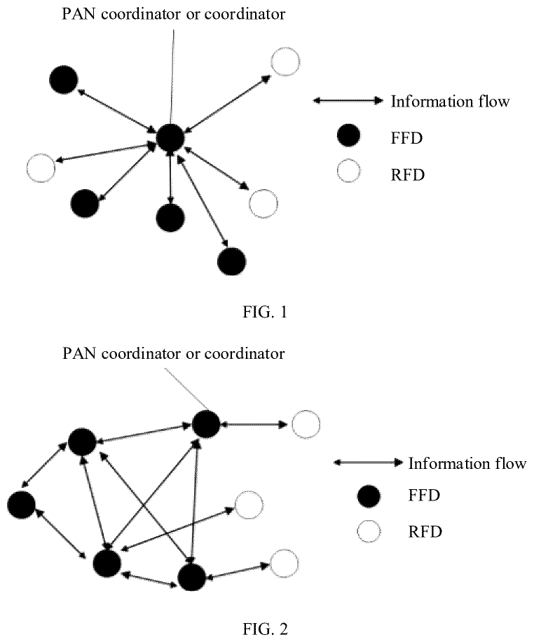

The technical solutions provided in embodiments of this disclosure may operate in a star topology, a point-to-point topology, or a mesh topology. FIG. 1 is a diagram of a star topology according to an embodiment of this disclosure. As shown in FIG. 1, in the star topology, a central node may control data communication between one or more other devices.

It may be understood that a point-to-point topology may be considered as a special mesh topology. The point-to-point topology refers to a structure of data communication between two devices. As shown in FIG. 2, in a mesh topology, data communication may be performed between any two devices.

Optionally, in FIG. 1 or FIG. 2, a black node is a full-function device (FFD), and a white node is a reduced-function device (RFD). In a UWB system, the FFD may be an anchor device, or a label device having a strong computing capability, for example, a UWB label mounted on a smartphone. The RFD is a label device and has only a part of the computing capability. In a possible implementation, the FFD device may serve as a personal area network (PAN) coordinator or a coordinator, but the RFD cannot serve as the PAN coordinator or the coordinator.

UWB is a wireless carrier communication technology in which nanosecond-level narrow pulses is used for data transmission. The narrow pulses occupy a wide spectrum range and have extremely low radiation spectrum density. A UWB system has advantages such as high multi-path resolution, low power consumption, and high confidentiality. As the UWB technology is applied in the civil field, UWB wireless communication has become one of popular physical layer technologies for short-range and high-speed wireless networks.

Currently, the IEEE association has incorporated the UWB into the IEEE 802 series wireless standards of the IEEE association, and the UWB-based WPAN standard IEEE 802.15.4a and its evolution version IEEE 802.15.4z have been released. In three features of communication, ranging, and sensing, the UWB focuses more on ranging and sensing capabilities, and can use a single waveform to implement ranging while performing sensing.

When the UWB is applied to a sensing technology, when a sensing receiver is a receive device of a UWB signal, the sensing receiver needs to transmit a measurement result of a CIR to a sensing transmitter through an air interface, to feed back a sensing result. In a CIR window-based (or referred to as feedback window-based) CIR feedback mechanism, the sensing receiver may send, to the sensing transmitter based on an indication of a CIR tap that needs to be fed back, the CIR tap that is in a CIR window and that needs to be fed back, to feed back the sensing result. Each CIR tap may indicate a sensing result of a specific time granularity in the CIR window. The indication may indicate the CIR tap that needs to be fed back. Therefore, the sensing receiver may send only the CIR tap that needs to be fed back, and does not need to send a CIR tap other than the CIR tap that needs to be fed back, to reduce overheads. It may be understood that, a time domain granularity of each CIR tap is, for example, 1 nanosecond (ns). The CIR window may include a maximum of 32, 64, 128, or 256 CIR taps. In other words, a length of the CIR window may be 32 ns, 64 ns, 128 ns, or 256 ns.

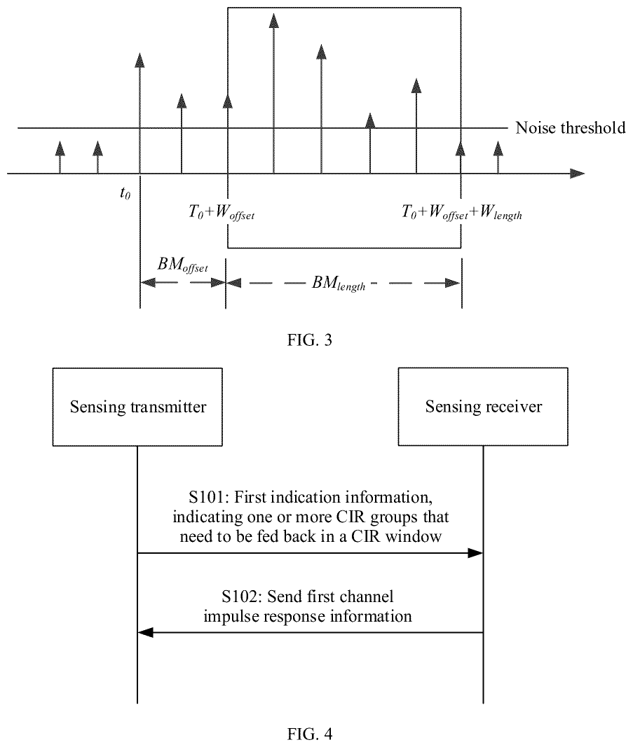

As shown in FIG. 3, to represents a reference point, namely, an earliest detected tap (earliest detected tap). The sensing transmitter may indicate a location of the CIR window through BM_{offset} and BM_{length}. BM_{offset} represents an interval between a start location of the CIR window and t₀. For example, BM_{offset} may indicate a quantity W_{offset} of CIR taps between the start location of the CIR window and t₀, and the start location of the CIR window may be denoted as (t₀+W_{offset}). BM_{length} represents a length of the CIR window, for example, indicates a quantity W_{length} of CIR taps between an end location of the CIR window and the start location of the CIR window. Therefore, it may be said that a location of the CIR window starts from (t₀+W_{offset}), and ends at (t₀+W_{offset}+W_{length}). W_{offset} is the quantity of CIR taps indicated by BM_{offset}, and W_{length} is the quantity of CIR taps indicated by BM_{length}.

In the CIR window-based CIR feedback mechanism, the sensing transmitter indicates, through signaling, whether each CIR tap is a CIR tap that needs to be fed back by the sensing receiver. For example, the CIR window includes the 256 CIR taps. The sensing transmitter needs to indicate, by using information (for example, a bitmap) with a length of 256 bits, whether each CIR tap needs to be fed back, and indication overheads are excessively high. Each bit corresponds to one CIR tap. For example, when a value of any bit is 1 (or may be 0), it represents that a corresponding CIR tap needs to be fed back. Correspondingly, the sensing receiver sends, to the sensing transmitter, the CIR tap that needs to be fed back.

To reduce the indication overheads of the CIR tap that needs to be fed back, an embodiment of this disclosure provides a communication method. The communication method may be performed by a first communication apparatus and a second communication apparatus. The first communication apparatus may be a sensing receiver or a component of the sensing receiver, and the second communication apparatus may be a sensing transmitter or a component of the sensing transmitter. The component in this disclosure may include, for example, at least one of a chip, a chip system, a processor, a transceiver, a processing unit, or a transceiver unit. It may be understood that the sensing transmitter may be a network device or a terminal device, and the sensing receiver may be a network device or a terminal device.

As shown in FIG. 4, for example, execution bodies are the sensing transmitter and the sensing receiver. The communication method provided in embodiments of this disclosure may include the following steps.

S101: The sensing receiver receives first indication information, where the first indication information indicates one or more CIR groups that need to be fed back in a CIR window. Each CIR group that needs to be fed back includes an (s₁2^{t}^{₁}+1)^{th} CIR tap and an (s₂2^{t}^{₂})^{th} CIR tap that are in the CIR window, and all CIR taps between the (s₁2^{t}^{₁}+1)^{th} CIR tap and the (s₂2^{t}^{₂})^{th} CIR tap. s₁ and s₂ are positive integers, and t₁ and t₂ are positive integers.

Correspondingly, the first indication information may be sent by the sensing transmitter.

It can be learned that the CIR taps in the CIR window may be divided into the one or more CIR groups, and each CIR group may include consecutive s₂2^{t}^{₂}−s₁₂t₁ CIR taps. It can be learned from a physical meaning of the CIR tap that a segment of consecutive CIR taps (that is, a plurality of consecutive CIR taps) may reflect information about a target sensed within a given distance. Therefore, during CIR feedback, only the segment of consecutive CIR taps needs to be considered for feedback. A length of the consecutive CIR taps that need to be fed back is related to a distance range in which the target is located. Therefore, in S101, a plurality of consecutive CIR taps may be used as one CIR group, and the first indication information may indicate at least one CIR group that needs to be fed back. Therefore, a feedback of the segment of consecutive CIR taps can be indicated, and indication overheads can be reduced in comparison with a solution of indicating whether each CIR tap needs to be fed back.

The following describes, with reference to examples, several possible grouping manners of all the CIR taps in the CIR window, and manners that are indicated by first indication information corresponding to the grouping manners and that are of CIR groups that need to be fed back.

Example 1: One piece of N-bit data is used as the first indication information, and represents a segment of consecutive CIR taps whose length is an integer power of 2 in the CIR window, and locations of the consecutive CIR taps. The segment of consecutive CIR taps is used as a CIR group that needs to be fed back. In Example 1, a maximum quantity of supported CIR groups is 2^{N-1}. In other words, the first indication information of the length of N bits may indicate that any CIR group in CIR groups whose quantity does not exceed 2^{N-1} is used as the CIR group that needs to be fed back. N is an integer greater than 1.

In a possible implementation of Example 1, when a length of the CIR window is known or a length of the CIR window is given, a quantity of consecutive CIR taps that are fed back may be limited to the integer power of 2, that is, a length of each CIR group may be 1, 2, 4, 8, 16, 32, and the like. It is assumed that the length of the CIR window is L (that is, the CIR window includes L CIR taps). An N-bit binary number k may represent the segment of consecutive CIR taps whose length is the integer power of 2 in the CIR window, and locations of the consecutive CIR taps.

It is assumed that a quantity of all the CIR taps in the CIR window is L, the L CIR taps may be consecutively and evenly divided into 28 CIR groups. Therefore, each CIR group includes

$$Ng = \frac{L}{{2}^{g}}$$

CIR taps. Each CIR group or each CIR group that needs to be fed back includes a (2^{k}^{₁}+1)^{th} CIR tap and a (2^{k}^{₂})^{th} CIR tap that are in the CIR window, and all CIR taps between the (2^{k}^{₁}+1)^{th} CIR tap and the (2^{k}^{₂})^{th} CIR tap. k₁ and k₂ are non-negative integers. It is assumed that L=2^{K}, where k₁<k₂≤K. In other words, each CIR group includes 2^{k}^{₂}−2^{k}^{₁} CIR taps.

It may be understood that, for Example 1, s₁2^{t}^{₁}+1 shown in S101 is 2^{k}^{₁}+1, and s₂2^{t}^{₂} is 2^{k}^{₂}. In other words, s₁=s₂=1, t₁=k₁, and t₂=k₂.

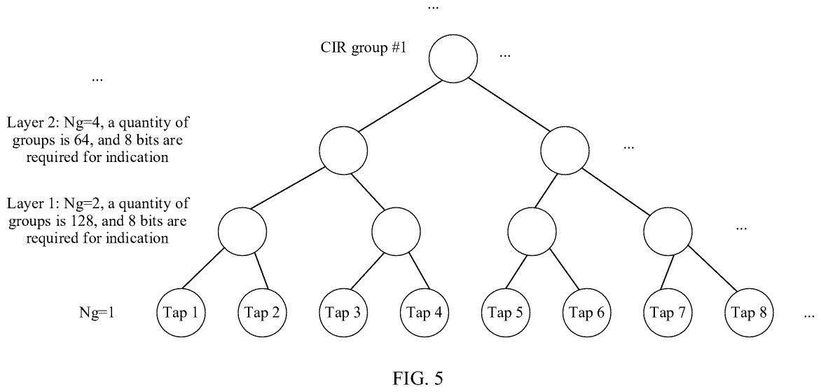

As shown in FIG. 5, the CIR taps in the CIR window may be grouped layer by layer. In addition, each blank circle in FIG. 5 may represent one CIR group, and each CIR group includes a plurality of taps at tap ends. For example, a CIR group #1 includes a CIR tap 1 to a CIR tap 8, which are represented as a tap 1 to a tap 8 in FIG. 5.

Each layer represents different 2^{g}, and 2^{g} is a quantity of groups; or may represent different Ng, and Ng is a quantity of CIR taps in each CIR group. When the quantity of groups is 1, that is, grouping is not performed, all the 256 CIR taps are fed back. When the quantity of groups is 2, a 1^{st} group includes a 1^{st} CIR tap to a 128^{th} CIR tap, and a 2^{nd} group includes a 129^{th} CIR tap to a 256^{th} CIR tap. When the quantity of groups is 4, a 1^{st} group includes the 1^{st} CIR tap to a 64^{th} CIR tap, a 2^{nd} group includes a 65^{th} CIR tap to the 128^{th} CIR tap, a 3^{rd} group includes the 129^{th} CIR tap to a 192^{nd} CIR tap, and a 4^{th} group includes the 193^{rd} CIR tap to the 256^{th} CIR tap. The rest may be deduced by analogy.

According to the foregoing grouping manner, all the CIR taps are grouped into 28 groups. Therefore, only g bits are required to indicate a location of each CIR group. Therefore, for the N-bit number k, a binary form of the N-bit number k is k=[b_{N-1}, b_{N-2}, . . . , b₁, b₀], and k may be designed to make

$$g = {max n .}_{{b}_{n} = 1}$$

2^{g} may represent the quantity of groups, and binary numbers [b_{g-1}, b_{g-2}, . . . , b₁, b₀] of the g bits may represent the location of the CIR group. In this way, the N-bit number k may represent any segment of groups whose quantity of all CIR groups does not exceed 2^{N-1} (that is, the quantity Ng of CIR taps included in each group

$$\geq \frac{L}{{2}^{N - 1}} ) .$$

N is a positive integer.

For example, when each CIR group includes at least Ng=4 CIR taps, and L=256, a location of any CIR group may be indicated by N=7 bits.

In addition, to further reduce feedback overheads, correspondences between CIR groups that need to be indicated and the first indication information may be preset. The CIR groups that need to be indicated in the correspondence may be some of all the CIR groups. There is a one-to-one correspondence between the first indication information and the CIR group that needs to be indicated. In other words, one piece of first indication information may indicate one CIR group that needs to be fed back. For example, as shown in Table 1, each row represents a correspondence between a feedback pattern index, and a CIR tap at a start location (start tap) and a CIR tap at an end location (end tap) that are in a CIR group. According to correspondences shown in Table 1, the first indication information may include one or more feedback pattern indexes, and each feedback pattern index may indicate any CIR group in Table 1 as the CIR group that needs to be fed back. When each CIR group includes at least Ng=4 CIR taps, and L=256, only 15 groups are selected from Table 1. Therefore, a maximum of 4 bits are required for feeding back the pattern indexes, so that the indication overheads can be further reduced. In Table 1, an example in which each CIR group includes the at least Ng=4 CIR taps and L=256 is used. Data in the table and a form of the table may be modified based on an actual requirement.

TABLE 1

CIR group

| Feedback pattern index | Start tap | End tap |
|---|---|---|
| 0 | 1 | 256 |
| 1 | 1 | 128 |
| 2 | 1 | 64 |
| 3 | 1 | 32 |
| 4 | 129 | 256 |
| 5 | 65 | 128 |
| 6 | 33 | 64 |
| 7 | 129 | 192 |
| 8 | 65 | 96 |
| 9 | 97 | 128 |
| 10 | 193 | 256 |
| 11 | 129 | 160 |
| 12 | 161 | 192 |
| 13 | 193 | 224 |
| 14 | 225 | 256 |

It may be understood that each CIR group in Table 1 includes the start tap, the end tap, and all CIR taps between the start tap and the end tap. The start tap and the end tap represent locations of CIR taps in the CIR window. For example, if the start tap is 1, it represents a 1^{st} CIR tap in the CIR window.

Optionally, the correspondence shown in Table 1 may be preconfigured or predefined, or may be determined by the sensing transmitter and the sensing receiver through negotiation (or interaction).

Example 2: One piece of N-bit data is used as the first indication information, and represents a plurality of segments of consecutive CIR taps whose lengths are integer powers of 2 in the CIR window, and locations of the plurality of segments of consecutive CIR taps. The plurality of segments of consecutive CIR taps are used as CIR groups that need to be fed back. In Example 2, the grouping manner described in Example 1 may still be used. For example, a quantity of CIR groups that need to be fed back is 2. A 1^{st} CIR group that needs to be fed back includes a (2^{k}^{₁}+1)^{th} CIR tap and a (2^{k}^{₂})^{th} CIR tap that are in the CIR window, and all CIR taps between the (2^{k}^{₁}+1)^{th} CIR tap and the (2^{k}^{₂})^{th} CIR tap. k₁ and k₂ are non-negative integers. A 2^{nd} CIR group that needs to be fed back includes a (2^{k}^{₃}+1)^{th} CIR tap and a (2^{k}^{₄})^{th} CIR tap that are in the CIR window, and all CIR taps between the (2^{k}^{₃}+1)^{th} CIR tap and the (2^{k}^{₄})^{th} CIR tap. k₃ and k₄ are non-negative integers, and k₃<k₄≤K. It is assumed that L=2K, where k₁<k₂≤K and k₃<k₄≤K. In other words, each CIR group includes 2^{k}^{₂}−2^{k}^{₁} CIR taps.

For example, when each CIR group includes at least Ng=4 CIR taps, and L=256, the quantity of groups may be 64, and the first indication information may include a plurality of N-bit binary numbers indicating a plurality of CIR groups that need to be fed back.

In example 2, to further reduce feedback overheads, correspondences between CIR groups that need to be indicated and the first indication information may be preset. The CIR groups that need to be indicated in the correspondence may be some of all the CIR groups. There is a one-to-many correspondence between the first indication information and the CIR groups that need to be indicated. In other words, one piece of first indication information may indicate a plurality of CIR groups that need to be fed back.

As shown in Table 2, each row represents a correspondence between a feedback pattern index and one or two CIR groups. Therefore, one feedback pattern index may indicate one or more CIR groups. For example, when the feedback pattern index is 15, it indicates that a CIR group 1 that needs to be fed back is from a 1^{st} CIR tap to a 64^{th} CIR tap, and a CIR group 2 that needs to be fed back is from a 129^{th} CIR tap to a 252^{nd} CIR tap. It can be learned that in the example shown in Table 2, a maximum of 4 bits are required to indicate 16 combinations of CIR groups that need to be fed back.

In Table 2, an example in which each CIR group includes the at least Ng=4 CIR taps and L=256 is used. Data in the table and a form of the table may be modified based on an actual requirement.

TABLE 2

| | CIR group 1 | | CIR group 2 | |
|---|---|---|---|---|
| Feedback pattern index | Start tap | End tap | Start tap | End tap |
| 0 | 1 | 256 | n | n |
| 1 | 1 | 128 | n | n |
| 2 | 1 | 64 | n | n |
| 3 | 1 | 32 | n | n |
| 4 | 1 | 16 | n | n |
| 5 | 1 | 8 | n | n |
| 6 | 1 | 4 | n | n |
| 7 | 1 | 32 | 65 | 96 |
| 8 | 1 | 32 | 97 | 128 |
| 9 | 1 | 32 | 129 | 160 |
| 10 | 1 | 32 | 161 | 192 |
| 11 | 1 | 32 | 193 | 224 |
| 12 | 1 | 32 | 225 | 256 |
| 13 | 1 | 64 | 129 | 192 |
| 14 | 1 | 64 | 193 | 256 |
| 15 | 1 | 64 | 129 | 252 |
| . . . | . . . | . . . | . . . | . . . |

Similarly to Table 1, each CIR group in Table 2 includes the start tap, the end tap, and all CIR taps between the start tap and the end tap. The start tap and the end tap represent locations of CIR taps in the CIR window. For example, if the start tap is 1, it represents a 1^{st} CIR tap in the CIR window.

As shown in Table 2, a start location of each CIR group 1 in Table 2 is 1. This is an optional solution used to simplify design complexity of a feedback pattern. A 1^{st} CIR tap that needs to be fed back may be used as the 1^{st} CIR tap in the CIR window by designing a value of BM_{offset}. For example, a value of BM_{offset} shown in FIG. 3 is a quantity of intervals between the 1^{st} CIR tap that needs to be fed back and a CIR tap at t₀.

Optionally, the correspondence shown in Table 2 may be preconfigured or predefined, or may be determined by the sensing transmitter and the sensing receiver through negotiation (or interaction).

Example 3: The first indication information includes an indication indicating a start location of a CIR tap that needs to be fed back and an indication indicating an end location of a CIR tap that needs to be fed back. Correspondingly, CIR taps that need to be fed back are CIR taps that include the CIR tap at the start location, the CIR tap at the end location, and CIR taps between the start location and the end location. Therefore, these CIR taps are used as a CIR group that needs to be fed back.

In Example 3, it is assumed that a minimum group of CIR taps in the CIR window includes 2^{d} CIR taps, and the CIR window includes 2K CIR taps. A sequential number of a start CIR tap of each CIR group may be denoted as k₅2^{d}+1, and a sequential number of an end CIR tap of the CIR group may be denoted as (k₆+1)2^{d}. K and d are positive integers, and K>d.

It may be understood that, for Example 3, s₁2^{t}^{₁}+1 shown in S101 is k₅2^{d}+1, and s₂2^{t}^{₂} is (k₆+1)2^{d}. In other words, s₁=k₅, s₂=k₆+1, and t₁=t₂=d.

In Example 3, because each CIR group includes at least 2^{d} CIR taps, there are 2^{l-d} possible values for each of k₁ and k₂, and k₁∈[0, 2^{K-d}−1], k₂∈[0, 2^{K-d}−1]. Therefore, K−d bits may be used to record the start location of each CIR group, and K−d bits may be used to record the end location of each CIR group. In other words, a total of 2(K−d) bits may be required to indicate a start location and an end location of one CIR group. Therefore, the total of 2(K−d) bits may be required to indicate the CIR group.

In a possible implementation of Example 3, the first indication information may include a binary number of the 2(K−d) bits. First K−d bits of the binary number indicate k₅, and last K−d bits of the first indication information indicate k₆. Therefore, it may be determined that a (k₅2^{d}+1)^{th} CIR tap to a ((k₆+1)2^{d})^{th} CIR tap that are in a CIR reference are CIR taps that need to be fed back.

For example, when d=5, a length of the CIR window is 2K=256, only 3 bits are required to indicate the start location of the CIR group, 3 bits indicate the end location of the CIR group, and only 6 bits of information are required to completely indicate a feedback format of a segment of consecutive CIR taps. The first 3 three bits may indicate a sequential number, of a 1^{st} CIR tap in the CIR group, in the CIR window, and the last 3 bits may indicate a sequential number, of a last CIR tap in the CIR group, in the CIR window.

Optionally, in Example 3, a value of d may be preconfigured or predefined, or may be determined by the sensing transmitter and the sensing receiver through negotiation (or interaction).

S102: The sensing receiver sends first CIR information, where the first CIR information is the one or more CIR groups that are indicated by the first indication information and that need to be fed back.

Correspondingly, the sensing transmitter may receive the first CIR information, and perform sensing based on the first CIR information.

According to the method shown in FIG. 4, the first indication information needs to indicate only the one or more CIR groups that need to be fed back in the CIR window, and does not need to indicate, for each CIR tap, whether the CIR tap needs to be fed back, thereby reducing the indication overheads.

It may be understood that the first CIR information in S102 may be understood as a set of CIR results that need to be fed back, that is, a set of CIR taps that need to be fed back. For example, the first CIR information includes all CIR taps in the one or more CIR groups that are indicated by the first indication information and that need to be fed back.

For example, for the indication manner shown in Example 1, the first CIR information may include the CIR group corresponding to the first indication information. The CIR group may include the (2^{k}^{₁}+1)^{th} CIR tap and the (2^{k}^{₂})^{th} CIR tap that are in the CIR window, and all the CIR taps between the (2^{k}^{₁}+1)^{th} CIR tap and the (2^{k}^{₂})^{th} CIR tap. k₁ and k₂ are the non-negative integers, and k₁<k₂≤K.

For the indication manner shown in Example 2, the first CIR information may include the one or more CIR group corresponding to the first indication information. For example, the first indication information includes two CIR groups, a 1^{st} CIR group may include the (2^{k}^{₁}+1)^{th} CIR tap and the (2^{k}^{₂})^{th} CIR tap that are in the CIR window, and all the CIR taps between the (2^{k}^{₁}+1)^{th} CIR tap and the (2^{k}^{₂})^{th} CIR tap. k₁ and k₂ are the non-negative integers, and k₁<k₂≤K. A 2^{nd} CIR group may include the (2^{k}^{₃}+1)^{th} CIR tap and the (2^{k}^{₄})^{th} CIR tap that are in the CIR window, and all the CIR taps between the (2^{k}^{₃}+1)^{th} CIR tap and the (2^{k}^{₄})^{th} CIR tap. k₃ and k₄ are the non-negative integers.

For the indication manner shown in Example 3, the first CIR information may include the (k₅2^{d}+1)^{th} CIR tap, the ((k₆+1)2^{d})^{th} CIR tap, and the CIR taps between the (k₅2^{d}+1)^{th} CIR tap and the ((k₆+1)2^{d})^{th} CIR tap. k₅ and k₆ are the non-negative integers, k₅∈[0, 2^{K-d}−1], and k₆∈[0, 2^{K-d}−1]. A quantity of all the CIR taps in the CIR window is 2K K and d are the positive integers, and K>d.

Based on a same concept, an embodiment of this disclosure further provides a communication apparatus. The communication apparatus may include corresponding hardware structures and/or software modules for performing the functions shown in the foregoing methods. A person skilled in the art should be easily aware that, in combination with the units and the method steps in the examples described in embodiments disclosed in this disclosure, this disclosure can be implemented by using hardware or a combination of hardware and computer software. Whether a function is performed through hardware or hardware driven by computer software depends on particular application scenarios and design constraint conditions of the technical solutions.

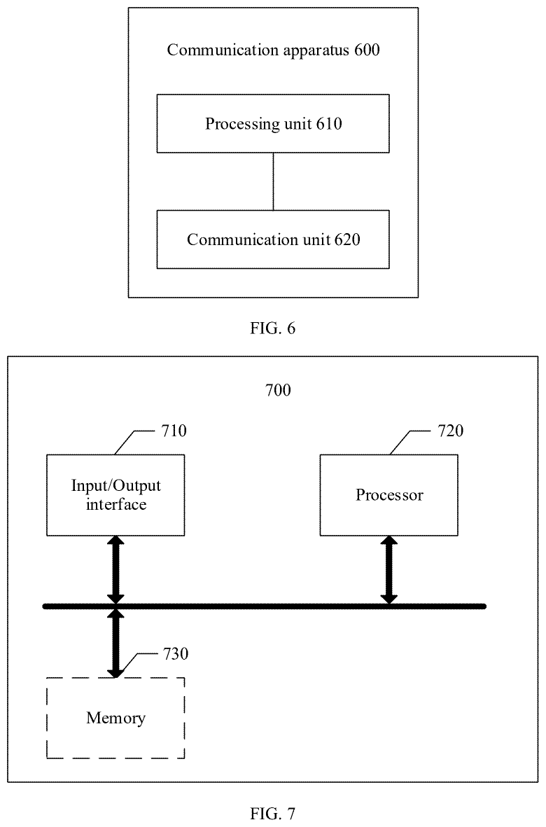

FIG. 6 to FIG. 8 are diagrams of structures of possible communication apparatuses according to embodiments of this disclosure. The communication apparatuses may be configured to implement functions of the sensing transmitter and/or the sensing receiver in the foregoing method embodiments, and therefore can also implement beneficial effect of the foregoing method embodiments. In a possible implementation, the communication apparatus may be a terminal device or a network device. For related details and effect, refer to the descriptions in the foregoing embodiments.

As shown in FIG. 6, the apparatus 600 includes a processing unit 610 and a communication unit 620. The communication unit 620 may implement a corresponding communication function, and the processing unit 610 is configured to process data. The communication unit 620 may include a sending unit and/or a receiving unit. The communication unit 620 may alternatively be a transceiver unit, an input/output interface, or the like. The communication apparatus 600 may be configured to implement functions of the sensing transmitter and/or the sensing receiver in the method embodiment shown in FIG. 2.

For example, when the function of the sensing receiver is implemented, the communication unit 620 may be configured to: receive first indication information, and send first CIR information.

For another example, when the function of the sensing transmitter is implemented, the communication unit 620 may be configured to: send first indication information, and receive first CIR information.

For meanings of the foregoing technologies, refer to the descriptions in the method embodiments. Details are not described again.

It may be further understood that in embodiments of this disclosure, division into modules is an example, and is merely logical function division. During actual implementation, there may be another division manner. In addition, functional modules in embodiments of this disclosure may be integrated into one processor, each module may exist alone physically, or two or more modules may be integrated into one module. The integrated module may be implemented in a form of hardware, or may be implemented in a form of a software function module.

FIG. 7 shows a communication apparatus 700 according to an embodiment of this disclosure. The communication apparatus 700 is configured to implement the communication method provided in this disclosure. The communication apparatus 700 may be a communication apparatus to which the communication method is applied, a component in the communication apparatus, or an apparatus that can be used in a matching manner with the communication apparatus. The communication apparatus 700 may be a sensing transmitter and/or a sensing receiver. The communication apparatus 700 may be a chip system or a chip. In this embodiment of this disclosure, the chip system may include a chip, or may include a chip and another discrete component. The communication apparatus 700 includes at least one processor 720, configured to implement the communication method provided in embodiments of this disclosure. The communication apparatus 700 may further include an input/output interface 710, and the input/output interface may include an input interface and/or an output interface. In this embodiment of this disclosure, the input/output interface 710 may be configured to communicate with another apparatus via a transmission medium, and a function of the input/output interface 710 may include sending and/or receiving. For example, when the communication apparatus 700 is the chip, the communication apparatus 700 performs transmission with another chip or device through the input/output interface 710. The processor 720 may be configured to implement the method shown in the foregoing method embodiments.

For example, the processor 720 may be configured to perform an action performed by the processing unit 610, and the input/output interface 710 may be configured to perform an action performed by the communication unit 620. Details are not described again.

Optionally, the communication apparatus 700 may further include at least one memory 730, configured to store program instructions and/or data. The memory 730 is coupled to the processor 720. The coupling in embodiments of this disclosure may be indirect coupling or a communication connection between apparatuses, units, or modules in an electrical form, a mechanical form, or another form, and is used for information exchange between the apparatuses, the units, or the modules. The processor 720 may cooperate with the memory 730. The processor 720 may execute the program instructions stored in the memory 730. At least one of the at least one memory may be integrated with the processor.

In this embodiment of this disclosure, the memory 730 may be a non-volatile memory, for example, a hard disk drive (HDD) or a solid-state drive (SSD), or may be a volatile memory, for example, a random-access memory (RAM). The memory is any other medium that can carry or store expected program code in a form of instructions or a data structure and that can be accessed by a computer, but is not limited thereto. The memory in this embodiment of this disclosure may alternatively be a circuit or any other apparatus that can implement a storage function, and is configured to store the program instructions and/or the data.

In this embodiment of this disclosure, the processor 720 may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in embodiments of this disclosure. The general-purpose processor may be a microprocessor or any other processor or the like. The steps of the method disclosed in embodiments of this disclosure may be directly performed by a hardware processor, or may be performed by using a combination of hardware and software modules in the processor.

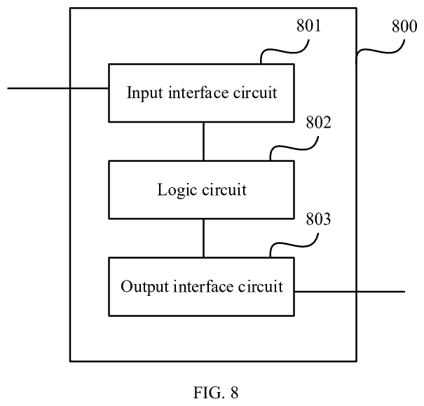

FIG. 8 shows a communication apparatus 800 according to an embodiment of this disclosure. The communication apparatus 800 is configured to implement the communication method provided in this disclosure. The communication apparatus 800 may be a communication apparatus to which the communication method shown in embodiments of this disclosure is applied, a component in the communication apparatus, or an apparatus that can be used in a matching manner with the communication apparatus. The communication apparatus 800 may be a sensing transmitter and/or a sensing receiver. The communication apparatus 800 may be a chip system or a chip. In this embodiment of this disclosure, the chip system may include a chip, or may include a chip and another discrete component. A part or all of the communication method provided in the foregoing embodiments may be implemented by hardware or software. When the communication method is implemented by hardware, the communication apparatus 800 may include an input interface circuit 801, a logic circuit 802, and an output interface circuit 803.

Optionally, an example in which the apparatus is configured to implement functions of a receiver is used. The input interface circuit 801 may be configured to perform a receiving action performed by the communication unit 620, the output interface circuit 803 may be configured to perform a sending action performed by the communication unit 620, and the logic circuit 802 may be configured to perform an action performed by the processing unit 610. Details are not described again.

Optionally, during specific implementation, the communication apparatus 800 may be a chip or an integrated circuit.

Some or all of operations and functions performed by the communication apparatus described in the foregoing method embodiments of this disclosure may be implemented by using the chip or the integrated circuit.

An embodiment of this disclosure provides a computer-readable storage medium storing a computer program. The computer program includes instructions for performing the foregoing method embodiments.

An embodiment of this disclosure provides a computer program product including instructions. When the computer program product runs on a computer, the computer is enabled to perform the foregoing method embodiments.

An embodiment of this disclosure provides a communication system, including a sensing transmitter and a sensing receiver.

It should be understood that the processor mentioned in embodiments of this disclosure may be a central processing unit (CPU), or may be another general-purpose processor, a digital signal processor (DSP), an application-specific integrated circuit (ASIC), a field-programmable gate array (FPGA) or another programmable logic device, a transistor logic device, a hardware component, or any combination thereof. The general-purpose processor may be a microprocessor or any other processor.

All or some of foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer instructions are loaded and executed on a computer, the procedure or functions according to embodiments of this disclosure are all or partially generated. The computer may be a general-purpose computer, a special-purpose computer, a computer network, or another programmable apparatus. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, through a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, an SSD), or the like.

The communication apparatus in the foregoing apparatus embodiments corresponds to the sensing transmitter and/or the sensing receiver in the method embodiments, and corresponding modules or units perform corresponding steps. For example, the communication unit (transceiver) performs a receiving or sending step in the method embodiments, and a step other than the sending step and the receiving step may be performed by the processing unit (processor). For a function of a specific unit, refer to a corresponding method embodiment. There may be one or more processors.

Terms such as “component”, “module”, and “system” used in this specification indicate computer-related entities, hardware, firmware, combinations of hardware and software, software, or software being executed. For example, a component may be, but is not limited to, a process that runs on a processor, a processor, an object, an executable file, an execution thread, a program, and/or a computer. As illustrated by using figures, both a computing device and an application that runs on the computing device may be components. One or more components may reside within a process and/or a thread of execution, and a component may be located on one computer and/or distributed between two or more computers. In addition, the components may be executed from various computer-readable media that store various data structures. For example, the components may communicate by using a local and/or remote process and based on a signal having one or more data packets (for example, data from two components interacting with another component in a local system, a distributed system, and/or across a network like the Internet interacting with another system by using the signal).

A person of ordinary skill in the art may be aware that, illustrative logical blocks and steps described in combination with embodiments disclosed in this specification can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this disclosure, it should be understood that the disclosed systems, apparatuses, and methods may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on an actual requirement to achieve the objectives of the solutions of embodiments.

In addition, functional units in embodiments of this disclosure may be integrated into one processing unit, or each of the units may exist alone physically, or two or more units may be integrated into one unit. When the functions are implemented in a form of software functional unit and sold or used as an independent product, the functions may be stored in a computer-readable storage medium.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method, comprising:
receiving first indication information indicating one or more first channel impulse response (CIR) groups that need to be fed back in a CIR window, wherein each of the one or more first CIR groups comprises an (s₁2^{t}^{₁}+1)^{th} CIR tap in the CIR window, an (s₂2^{t}^{₂})^{th} CIR tap in the CIR window, and all first CIR taps between the (s₁2^{t}^{₁}+1)^{th} CIR tap and the (s₂2^{t}^{₂})^{th} CIR tap, and wherein s₁, s₂, t₁, and t₂ are positive integers; and
sending first CIR information comprising the one or more first CIR groups.

2. The method of claim 1, wherein each of the one or more first CIR groups comprises s₂2^{t}^{₂}−s₁2^{t}^{₁} CIR taps.

3. The method of claim 1, wherein the CIR window comprises 2^{K} CIR taps in total, wherein K is a positive integer greater than 2, and wherein the 2^{K} CIR taps comprise a 1^{st} CIR tap, a (2^{K})^{th} CIR tap, and all second CIR taps between the 1^{st} CIR tap and the (2^{K})^{th} CIR tap.

4. The method of claim 1, wherein the one or more first CIR groups comprise a second CIR group, wherein the second CIR group comprises a (2^{k}^{₁}+1)^{th} CIR tap, a (2^{k}^{₂})^{th} CIR tap, and all second CIR taps between the (2^{k}^{₁}+1)^{th} CIR tap and the (2^{k}^{₂})^{th} CIR tap, wherein k₁ and k₂ are non-negative integers, wherein k₁<k₂≤K, and wherein K is a positive integer greater than 2.

5. The method of claim 4, wherein the first indication information corresponds to the second CIR group.

6. The method of claim 4, wherein the first CIR information further comprises a third CIR group, wherein the third CIR group comprises a (2^{k}^{₃}+1)^{th} CIR tap, a (2^{k}^{₄})^{th} CIR tap, and all third CIR taps between the (2^{k}^{₃}+1)^{th} CIR tap and the (2^{k}^{₄})^{th} CIR tap, wherein k₃ and k₄ are non-negative integers, and wherein k₃<k₄≤K.

7. The method of claim 6, wherein the first indication information corresponds to the first CIR group and the second CIR group.

8. The method of claim 1, wherein a 1^{st} CIR tap in the first CIR information is a (k₅2^{d}+1)^{th} CIR tap in the CIR window, wherein a last CIR tap in the first CIR information is a ( [symbol] (k [symbol] ₆+1)2^{d})^{th} CIR tap in the CIR window, wherein d is a positive integer, wherein K>d, wherein K is a positive integer greater than 2, wherein k₅ and k₆ are non-negative integers, wherein k₅∈[0, 2^{K-d}−1], and wherein k₆∈[0, 2^{K-d}−1].

9. The method of claim 8, wherein the first indication information comprises 2(K−d) bits, wherein first K−d bits in the first indication information indicate k₅, and wherein last K−d bits in the first indication information indicate k₆.

10. An apparatus, comprising:
a memory configured to store instructions; and
one or more processors coupled to the memory and configured to execute the instructions to cause the apparatus to:
receive first indication information indicating one or more first channel impulse response (CIR) groups that need to be fed back in a CIR window, wherein each of the one or more first CIR groups comprises an (s₁2^{t}^{₁}+1)^{th} CIR tap in the CIR window, an (s₂2^{t}^{₂})^{th} CIR tap in the CIR window, and all first CIR taps between the (s₁2^{t}^{₁}+1)^{th} CIR tap and the (s₂2^{t}^{₂})^{th} CIR tap, and wherein s₁, s₂, t₁, and t₂ are positive integers; and
send first CIR information comprising the one or more first CIR groups.

11. The apparatus of claim 10, wherein each of the one or more first CIR groups comprises s₂2^{t}^{₂}−s₁2^{t}^{₁} CIR taps.

12. The apparatus of claim 10, wherein the CIR window comprises 2^{K} CIR taps in total, wherein K is a positive integer greater than 2, and wherein the 2^{K} CIR taps comprise a 1^{st} CIR tap, a (2^{K})^{th} CIR tap, and all second CIR taps between the 1^{st} CIR tap and the (2^{K})^{th} CIR tap.

13. The apparatus of claim 10, wherein the one or more first CIR groups comprises a second CIR group, wherein the second CIR group comprises a (2^{k}^{₁}+1)^{th} CIR tap, a (2^{k}^{₂})^{th} CIR tap, and all second CIR taps between the (2^{k}^{₁}+1)^{th} CIR tap and the (2^{k}^{₂})^{th} CIR tap, wherein k₁ and k₂ are non-negative integers, wherein k₁<k₂≤K, and wherein K is a positive integer greater than 2.

14. The apparatus of claim 13, wherein the first indication information corresponds to the second CIR group.

15. The apparatus of claim 14, wherein the first CIR information further comprises a third CIR group, wherein the third CIR group comprises a (2^{k}^{₃}+1)^{th} CIR tap, a (2^{k}^{₄})^{th} CIR tap, and all third CIR taps between the (2^{k}^{₃}+1)^{th} CIR tap and the (2^{k}^{₄})^{th} CIR tap, wherein k₃ and k₄ are non-negative integers, and wherein k₃<k₄≤K.

16. The apparatus of claim 15, wherein the first indication information corresponds to the first CIR group and the second CIR group.

17. The apparatus of claim 10, wherein a 1^{st} CIR tap in the first CIR information is a (k₅2^{d}+1)^{th} CIR tap in the CIR window, wherein a last CIR tap in the first CIR information is a ( [symbol] (k [symbol] ₆+1)2^{d})^{th} CIR tap in the CIR window, wherein d is a positive integer, wherein K>d, wherein k₅ and k₆ are non-negative integers, wherein k₅∈[0, 2^{K-d}−1], and wherein k₆∈[0, 2^{K-d}−1].

18. The apparatus of claim 17, wherein the first indication information comprises 2(K−d) bits, wherein first K−d bits in the first indication information indicate k₅, and wherein last K−d bits in the first indication information indicate k₆.

19. A computer program product comprising instructions that are stored on a non-transitory computer-readable storage medium and that, when executed by one or more processors, cause an apparatus to:
receive first indication information indicating one or more first channel impulse response (CIR) groups that need to be fed back in a CIR window, wherein each of the one or more CIR groups comprises an (s₁2^{t}^{₁}+1)^{th} CIR tap in the CIR window, an (s₂2^{t}^{₂})^{th} CIR tap in the CIR window, and all first CIR taps between the (s₁2^{t}^{₁}+1)^{th} CIR tap and the (s₂2^{t}^{₂})^{th} CIR tap, and wherein s₁, s₂, t₁, and t₂ are positive integers; and
send first CIR information comprising the one or more first CIR groups.

20. The computer program product of claim 19, wherein each of the one or more first CIR groups comprises s₂2^{t}^{₂}−s₁2^{t}^{₁} CIR taps.
